(19) United States
(12) Patent Application Publication
(10) Pub. No.: US 2010/0282012 A1
(43) Pub. Date: Nov. 11, 2010

(54) Skew Gear with Attenuation

(75) Inventors: Olaf Beutler, Diepholz (DE); Remt Blankenspeck, Drebber (DE); Waldemar Rogowski, Lotte (DE); Gunter Lohfink, Bad Harzburg (DE)

Correspondence Address: Hildebrand, Christa;Norris McLaughlin & Marcus PA, 875 Third Avenue, 8th Floor, New York, NY, 10022, US

(73) Assignee: ZF Friedrichshafen AG, Friedrichshafen (DE)

(21) Appl. No.: 12/810,354

(22) PCT Filed: Dec. 10, 2008
(86) PCT No.: PCT/DE2008/050040

§ 371 Date: Jun. 24, 2010

(30) Foreign Application Priority Data
Jan. 31, 2008 (DE) 10 2008 007 105.6

(51) Int. Cl. F16H 55/14

(52) U.S. Cl. 74/443

(57) ABSTRACT

The invention relates to a skew gear constructed as a built skew gear and provided with attenuation. The skew gear wheel has a first flange for rotation-locked arrangement of the skew gear on a shaft or a pinion, a second flange or a disk, and a ring gear arranged and rotatable therebetween. The two flanges, or the first flange and the disk, are frictionally or positively connected with one another, wherein their respective elements providing the connection extend through the ring gear in the axial direction. According to the invention, at least one elastomeric element is overmolded on an inside contour of the ring gear for forming the attenuation, so that the ring gear and the attenuation form a single unit.

The invention relates to a skew gear with attenuation. The invention relates more particularly to a skew gear made of several components to be used for a steering gear. Accordingly, the skew gear is a so-called built skew gear.

Conventional skew gears of this type are constructed, for example, of a ring gear made of plastic or metal and flanges arranged axially on both sides of the ring gear, with which the ring gear is stabilized and the skew gear can be mounted on a shaft with a rotation-lock. The ring gear and the flanges are hereby frictionally and/or positively connected with each other and hence radially, axially and torsionally locked in position with respect to one another.

A skew gear of this type is disclosed, for example, in EP 1 339 569 B1 and DE 10 2006 010 270 A1. The skew gears described in these documents have, at least according to the advantageous embodiments described therein, elastomeric attenuation elements which are arranged between the flanges and the ring gear in form of O-rings. These attenuation elements dampen axial and radial vibrations as well as torsional loads operating on steering gears equipped with these skew gears, and enhance the driving comfort. As illustrated in the figures of the aforementioned documents, corresponding skew gears, including the preferably provided attenuation elements, have a sizable number of individual components requiring assembly. The manufacturing complexity of such skew gear increases with the number of the components that need to be assembled to a skew gear. This manufacturing disadvantage translates into increased manufacturing costs.

It is an object of the invention to provide a skew gear with attenuation, which has a simpler structure than conventional devices and is therefore easier to manufacture at lower costs. The corresponding skew gear should also exhibit effective attenuation both with respect to axial and radial vibrations as well as torsional loads.

The object is solved by a skew gear having the features of the independent claim. Advantageous embodiments or modifications of the invention are recited in the dependent claims.

The skew gear proposed for attaining the object is, as already mentioned at the beginning, constructed as a built toothed wheel. It is constructed of a first flange for rotation-locked arrangement of the skew gear on a shaft or a pinion, a second flange or a disk, and a ring gear arranged between and rotatable relative to the first and second flange or disk. Both flanges, or the first flange and the disk, respectively, are frictionally or positively connected with one another, wherein their elements forming the connection extend through the ring gear in the axial direction. The skew gear is provided with attenuation, which dampens relative movement between the ring gear in relation to the two flanges, or in relation to the flange and the disk.

According to the invention, the ring gear and the attenuation form a single unit, whereby the attenuation is formed by overmolding at least one elastomeric element on an inner contour of the ring gear. The overmolded elastomeric element according to the invention dampens at least the produced torsional forces associated with the twistability of the ring gear. However, when the skew gear is in operation and meshes with a worm, radial and axial forces associated with the rotation of the ring gear are also produced, which caused the ring gear to be pressed against portions or flat sections of the two flanges, or of the first flange and the disk, respectively. Preferably, these forces must also be damped for enhancing the driving comfort. According to a preferred embodiment of the invention, an effective torsional as well as axial and radial attenuation is realized with the elastomeric element(s).

A practical embodiment of the skew gear according to the invention is provided by arranging several inwardly projecting ribs, which are uniformly distributed along the circumference, on the radially inner side of the ring gear in a first axial plane and in a second axial plane. The respective ribs each have on their radially inward ends, in relation to the circumferential direction, a contour acting as a barb. The overmolded elastomer engages with this barb-like contour by providing at least torsionally effective attenuation.

The aforedescribed embodiment is preferably configured by arranging the ribs disposed in the first axial plane with an offset in the circumferential direction in relation to the ribs disposed in the second axial plane. At least two ribs are arranged in each of the two axial planes, wherein the angle, by which the ribs of the first axial plane are offset with respect to the ribs of the second plane, is equal to the portion of the full circle angle of 360° that corresponds to the total number of ribs of both axial planes. In this way, in relation to the circumferential direction, a rib of the corresponding other axial plane is always arranged midway between the ribs of an axial plane.

The aforementioned embodiment with the ribs arranged in two planes and provided with a barbed structure on both sides is advantageously modified by providing attenuation with a one-piece elastomeric element which surrounds the outside contours of the inwardly protruding ribs of the ring gear. A circumferential elastomeric ring is formed on the inside circumference of the ring gear between the two rib planes of the ring gear, which is formed during the manufacturing process by the elastomer flowing into the suitable shaped mold and around the ribs having the barbs. Attenuation is therefore provided by a single element or a one-piece element.

Radially effective attenuation is realized in the skew gear formed with ribs surrounded by the elastomer by overmolding a bulge on the elastomer at the center of the axial end of the ribs covered with the elastomer, or more precisely on the respective end faces of the ribs. Axial attenuation is achieved because the bulge overlaps the ribs towards the axial center of the ring gear, namely up to the axial center of the ring gear, or even beyond.

Details of the invention will now be described in more detail with reference to an exemplary embodiment. The accompanying drawings show in:

FIG. 1 a possible embodiment of the skew gear according to the invention in a three-dimensional view,

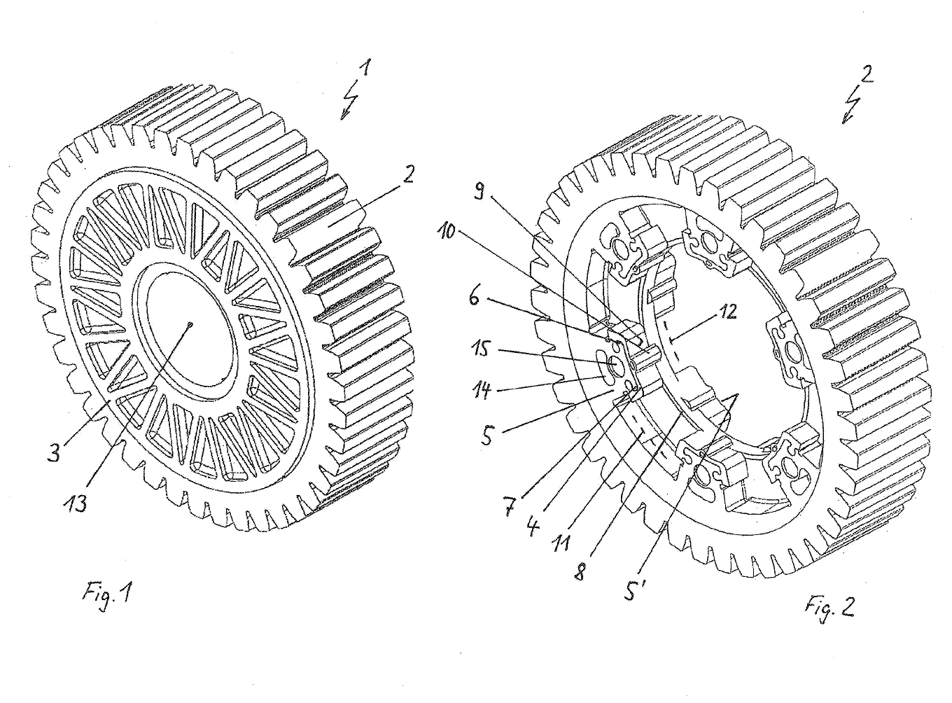

FIG. 2 the ring gear of the skew gear of FIG. 1 in a three-dimensional view,

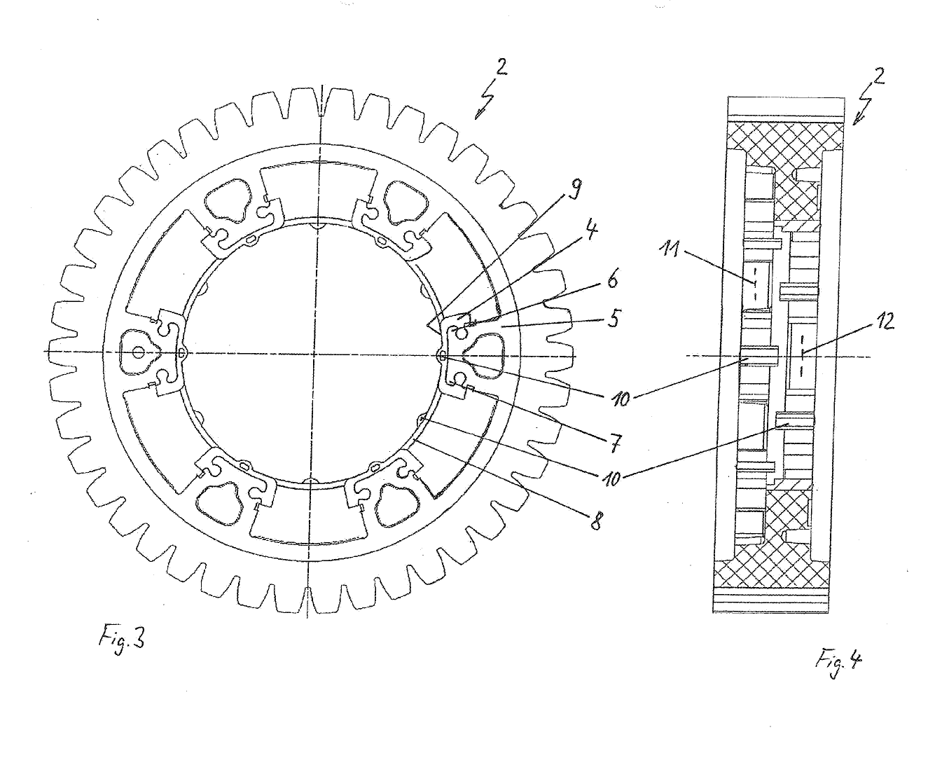

FIG. 3 the ring gear according to FIG. 2 in a top view in the axial direction, and

FIG. 4 the ring gear according to FIG. 3 in a radial sectional view.

FIG. 1 shows a possible exemplary embodiment of the skew gear 1 according to the invention. The figure shows the skew gear 1 in a three-dimensional view. As seen in the figure, the illustrated embodiment relates to a toothed skew gear 1 with straight teeth, wherein the width of the teeth of the ring gear 2 indicates that the skew gear 1 is configured for meshing with a worm.

The ring gear 2 is closed off of on the axial side visible in the drawing by a perforated disk 3, which is frictionally or positively connected with a flange (not visible in the figure) arranged on the axially opposing side. With the unillustrated flange, the skew gear 1 can be mounted rotation-locked on a shaft or a pinion. The shaft or the opinion extends through the circular central opening 13. The ring gear 2 is movable, i.e., rotatable, in the circumferential direction u relative to the (unillustrated) flange and the disk 3.

FIG. 2 shows once more the ring gear 2 of the skew gear 1 according to FIG. 1 without the disk 3 and the flange. This diagram shows the attenuation element which is formed according to the invention by an elastomeric element 4 which is overmolded on the inside contour of the ring gear 2. Visible in the foreground are several ribs 5 which are arranged in an axial plane 11 and are uniformly distributed along the circumference, and which protrude radially inwardly on the inside of the ring gear 2. Each of the ribs 5 has on its radially inside end, in relation to the circumferential direction u, on both sides a contour which acts as barbs 6, 7 or is barb-like. The elastomeric element 4 forming the attenuation element engages with this contour, whereby the elastomeric element 4 covers the radial ends of the ribs 5 in the region of the barbs 6, 7 and their end faces 9. On the side axially opposite the ribs 5 which are visible in the foreground, an identical number of likewise radially inward protruding ribs 5′ is arranged in a second axial plane 12. As can be seen, the ribs 5′ on the side that faces away in the axial direction are offset in the circumferential direction u by an angle of 30° with respect to the ribs 5 on the side of the ring gear 2 which is seen in the foreground in the axial direction. A fully circumferential elastomeric ring 8 is formed on the inside circumference of the toothed wheel 2 between the two planes 11, 12 of the ribs. This elastomeric ring 8 is produced during manufacture by the elastomer which flows into the correspondingly shaped mold and around the axial ends of the ribs 5, 5′, forming in the illustrated exemplary embodiment a one-piece attenuation element. As further illustrated in the figure, a bulge 10 is formed centrally on the elastomer which covers the radial end faces 9 of the ribs 5, 5′. This bulge 10 produces attenuation acting in the radial direction r.

The recesses 14 in the ribs 5 shown in the figure represent so-called relief cores. These are provided for manufacturing reasons and reduce the wall thickness in order to shorten the cycle time in the injection molding machine during the manufacture of the ring gear 2 formed as a molded part. Also visible are the overmolding points 15 by which the material is injected into the corresponding mold.

FIG. 4, which depicts once more the ring gear 2 of the skew gear 1 according to the invention in a radially cut view, shows that the aforementioned bulge 10 overlaps the ribs 5, 5′ inwardly, i.e., towards the axial center of the ring gear 2. This region overlapping the ribs 5, 5′ produces an attenuation effect in the axial direction a.

The ring gear 2 illustrated in a radially cut view of FIG. 4 is shown again in FIG. 3 in a top view from the axial direction a. The ring gear 2 in FIG. 3 is shown in a top view from the direction of the axial side facing away from the viewing plane of FIG. 2. Visible are here in particular the regions providing the torsional effect and the regions providing the radial effect of the attenuation element, whereby torsional attenuation is provided by the elastomer which covers the ribs 5, 5′in the region of the barbs 6, 7 formed on the ends of the ribs 5, 5′.

### LIST OF REFERENCES SYMBOLS

1 Skew gear
2 Ring gear
3 Disk
4 Elastomeric element
5, 5′ Rib
6, 7 Barb
8 Elastomeric ring
9 End face
10 Bulge
11, 12 (Axial) plane
13 Central opening
14 Recess
15 Overmolding point

1. A skew gear, constructed as a built toothed wheel, with a first flange for rotation-locked arrangement of the skew gear on a shaft or a pinion, a second flange or a disk which are frictionally or positively connected with the first flange, and a ring gear arranged between and rotatable relative to the second flange or disk, wherein the skew gear is provided with an attenuation element, by which the ring gear is attenuated with respect to the first flange and the second flange or the disk and the parts which connect the flanges or the disk and extend through the ring gear in the axial direction (a), wherein the ring gear and the attenuation element form a unit, and wherein the attenuation element is formed by overmolding at least one elastomeric element on an inner contour of the ring gear.

2. A skew gear according to claim 1, wherein torsionally as well as axially and radially effective attenuation is provided by the elastomeric element(s).

3. A skew gear according to claim 1, wherein on the radially inner side of the ring gear several inwardly projecting ribs, which are uniformly distributed along the circumference, are arranged in a first axial plane and in a second axial plane, wherein the ribs each have on their radially inward ends, in relation to the circumferential direction (u), a contour configured as a barb, with which the overmolded elastomer engages by forming an at least torsionally effective attenuation.

4. A skew gear according to claim 3, wherein the ribs disposed in the first axial plane are arranged with an offset in the circumferential direction (u) in relation to the ribs disposed in the second axial plane, wherein at least two ribs are arranged in each of the two axial planes and the angle, by which the ribs of the first axial plane are offset with respect to the ribs of the second plane, is equal to the portion of the full circle angle that corresponds to the total number of ribs of the two axial planes, so that in relation to the circumferential direction (u), a rib of an axial plane is always arranged midway between the ribs of the corresponding other axial plane.

5. A skew gear according to claim 3, wherein attenuation is provided by a one-piece elastomeric element, wherein a circumferential elastomeric ring having the ribs protruding in the radial direction (r) is formed on the inside circumference of the ring gear between the planes, with the elastomeric ring forming a unit with the elastomer covering the radially inner face of two ribs arranged axially on both sides of the elastomeric ring and in the region of the barbs to thereby provide the attenuation.

6. A skew gear according to of the claim 3, wherein the radially protruding ribs disposed on the inside of the ring gear are covered in the region of the barbs and on their radial face with the elastomer forming the attenuation, characterized in that the elastomer covering the faces of the ribs has in a center region of the end face of a corresponding rib a bulge producing an attenuation effect in the radial direction (r).

7. A skew gear according to claim 6, wherein the ribs are offset relative to one another in relation to the two planes, wherein the elastomeric bulges on the end faces of the ribs overlap the ribs in the axial direction (a) towards the axial center of the ring gear, or even beyond the axial center of the ring gear, thereby producing an attenuation effect in the axial direction (a).

8. A skew gear according to claim 4, wherein attenuation is provided by a one-piece elastomeric element, wherein a circumferential elastomeric ring having the ribs protruding in the radial direction (r) is formed on the inside circumference of the ring gear between the planes, with the elastomeric ring forming a unit with the elastomer covering the radially inner face of two ribs arranged axially on both sides of the elastomeric ring and in the region of the barbs to thereby provide the attenuation.
